(19) United States
(12) Patent Application Publication
(10) Pub. No.: US 2003/0063707 A1
(43) Pub. Date: Apr. 3, 2003

(54) Compact multispectral X-ray source

(76) Inventor: Gregory Anthony Mulhollan, Dripping Springs, TX (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 09/682,633

(22) Filed: Oct. 1, 2001

(51) Int. Cl. H01J 35/06

(52) U.S. Cl. 378/134

(57) ABSTRACT

An X-radiation source can comprise an electron emission layer and an anode layer. In an embodiment the anode layer may be no more than approximately 1000 microns from the emission layer or include an anode region that laterally surrounds a hole extending through the anode layer. In one embodiment, a plurality of electron emission tips, extraction gate electrodes and anode regions may be used. When the anode regions comprise different materials, a plurality of wavelengths may be emitted. In another embodiment, a monolithic structure can be formed using processing operations similar to those used in conventional semiconductor device manufacturing. The X-radiation source can be relatively small and may have uses in applications with confined spaces, such as medical applications.

### BACKGROUND OF INVENTION

1. Field of the Invention

This invention relates to the field of X-radiation sources. More particularly, this invention relates to X-radiation sources including anode layers and electron source layers and processes for forming the X-radiation sources.

2. Description of the Related Art

X-radiation is widely known and is used extensively for purposes such as material detection, chemical structure analysis, and medical treatment. X-radiation, or X-rays, may be produced by radioactive materials or through the stimulation of emission from other materials. For portable applications, or applications requiring a very small X-ray source, radioactive materials are often used. Radioactive materials, however, have many drawbacks including difficulties in handling, control of radiation intensity, cost, and the inability to control the x-ray spectrum. The production of a miniature, stimulated X-ray source can eliminate these problems.

To this end, X-ray sources have utilized a single, metal emitter tip to produce electrons by field emission. Because of the single emission tip however, a source of this design will not be able to produce sufficient X-ray energy or intensity for practical commercial application. Additionally, the size of such an X-ray source may be too large for many material analysis applications and particularly for medical applications where the source may be operated within human organs. The use of a gated array of molybdenum tips can generate higher electron current and thus reduces some problems of the single tip design. Metal tips however, have may have low emission uniformity and greater tip degradation than tips made from low work function materials. Neither design allows the x-ray spectrum to be easily varied.

The use of carbon-based field emission tips may provide better emission uniformity and device efficiency than metal tips. However current X-ray devices fabricated of carbon-based material generally do not produce multi-spectral X-ray emission or rapidly time-varying wavelengths from the x-ray source. Current carbon-based devices also may require complex and costly manufacturing processes, reducing their commercial potential.

### SUMMARY OF INVENTION

In embodiments described below, a process may overcome the problems above by enabling the inexpensive manufacture of an X-radiation source comprising an anode layer and electron source by standard, semiconductor photolithography. Embodiments also include apparatuses that may be miniature and may be easier to use in medical or analytical applications than current larger X-radiation devices. Further embodiments of the X-radiation source can provide mulitspectral X-radiation and may reduce process complexity and time in applications where multispectral X-radiation is currently not easily available.

In one set of embodiments, an X-radiation source comprises an electron emission layer comprising a first side and a first emission tip protruding from the first side, an anode layer located no more than approximately 1000 microns from the first side of the emission layer. In one embodiment, a gate electrode layer may be located between the electron emission layer and the anode layer.

In another set of embodiments, a process for forming an X-radiation source can comprise forming a first insulating layer over an emission layer with a first side. The emission layer may comprise at least a first emission tip protruding from the first side. The process can also comprise forming an extraction gate layer, a second insulating layer, and an anode layer. The second insulating layer, extraction gate layer, and first insulating layer may be etched to define openings in the second insulating layer, extraction gate layer, and first insulating layer, respectively. The openings can laterally surround a central axis of the first emission tip that can be substantially perpendicular to the first side of the emission layer.

Yet another embodiment includes an X-radiation source comprising an electron source. The anode layer can comprise a first anode region laterally surrounding a first hole extending through the anode layer. In a specific embodiment, the electron source may comprise a photo-emitter or the electron source can comprise an electron source layer having a first side and a first emission tip protruding from the first side. In another specific embodiment, the first hole may laterally surround a first axis extending through the first emission tip substantially perpendicular to the first side of said electron source.

The foregoing general description and the following detailed description are exemplary and explanatory only and are not restrictive of the invention as claimed.

### BRIEF DESCRIPTION OF DRAWINGS

The present invention is illustrated by way of example and not limitation in the accompanying figures.

FIG. 1 includes an illustration of a cross-sectional view of a portion of an electron emission layer with emission tips formed using a mold.

FIG. 2 includes an illustration of a cross-sectional view of a portion of the electron emission layer of FIG. 1 after the mold is removed and a first insulating layer is formed over the electron emission layer and emission tips.

FIG. 3 includes an illustration of a cross-sectional view of a portion of the electron emission layer of FIG. 2 after the first insulating layer has been planarized and an extraction gate layer has been formed over the first insulating layer and patterned.

FIG. 4 includes an illustration of a top view of a portion of the extraction gate layer of FIG. 3 where the extraction gate layer has been formed with separate extraction gate regions.

FIG. 5 includes an illustration of a cross-sectional view of a portion of the electron emission layer of FIG. 3 after forming a second insulating layer over the extraction gate layer.

FIG. 6 includes an illustration of a cross-sectional view of a portion of the electron emission layer of FIG. 5 after forming an anode layer over the second insulating layer and etching the anode layer to define openings that laterally surround central axes of the emission tips and expose the second insulating layer.

FIG. 7 includes an enlarged illustration of a cross-sectional view of a portion of the electron emission layer of FIG. 6 after forming an anode layer and etching the anode layer to define an opening that laterally surrounds a central axis of the emission tip.

FIG. 8 includes an illustration of a top view of a portion of the anode layer of FIG. 6 where the anode layer has been formed with separate anode regions.

FIG. 9 includes an illustration of a cross-sectional view of a portion of the electron emission layer of FIG. 7 after forming openings in the second insulating layer that laterally surround the central axes of the emission tips and expose the extraction gate layer.

FIG. 10 includes an illustration of a cross-sectional view of a portion of the electron emission layer of FIG. 9 after forming openings in the extraction gate layer that laterally surround the central axes of the emission tips and expose the first insulating layer.

FIG. 11 includes an illustration of a cross-sectional view of a portion of the electron emission layer of FIG. 10 after forming openings in the first insulating layer.

FIG. 12 includes an illustration of a cross-sectional view during an isotropic etching step of the first and second insulating layers.

FIG. 13 includes an illustration of a cross-sectional view of a portion of an X-radiation source where the anode layer seals a vacuum in the region existing between the anode layer and electron emission layer.

FIG. 14 includes an illustration of a cross-sectional view of a portion of an X-radiation source where the electron source comprises a photo-emitter layer.

Skilled artisans appreciate that elements in the figures are illustrated for simplicity and clarity and have not necessarily been drawn to scale. For example, the dimensions of some of the elements in the figures may be exaggerated relative to other elements to help improve understanding of embodiments of the present invention.

### DETAILED DESCRIPTION

Reference is now made in detail to the exemplary embodiments of the invention, examples of which are illustrated in the accompanying drawings. Wherever possible, the same reference numbers will be used throughout the drawings to refer to the same or like parts (elements).

An X-radiation source can comprise an electron emission layer and an anode layer. The anode layer may be no more than approximately 1000 microns from the emission layer or include an anode region that laterally surrounds a hole extending through the anode layer. In one embodiment, a plurality of electron emission tips, extraction gate electrodes and anode regions may be used. When the anode regions comprise different materials, a plurality of wavelengths may be emitted. In another embodiment, a monolithic structure can be formed using processing operations similar to those used in conventional semiconductor device manufacturing. The X-radiation source can be relatively small and may have uses in applications with confined spaces, such as medical applications. Attention is now directed to details of exemplary embodiments.

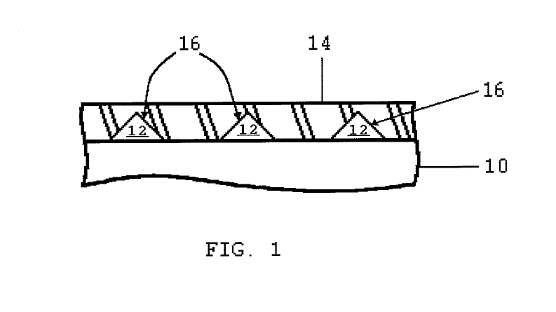

FIG. 1 includes an illustration of a portion of an electron emission layer 10 and multiple emission tips 12 formed using a mold 14. The mold 14 can have a substrate comprising pyramidal, conical, or otherwise shaped indentions 16 resulting in the emission tips 12. Pyramidal tips may have sides in the range of approximately 1-5 microns wide at the base and a height within the range of approximately 1-5 microns. The electron emission layer 10 and emission tip 12 may be a carbon-based material and the mold 14 may be silicon. In one embodiment, the electron emission layer 10 and emission tips 12 may be formed by growing a carbon-based film onto a mold 14 containing tip indentions using conventional techniques. After the emission tips 12 have sufficiently formed in the mold 14, the mold 14 may be removed. In another embodiment, the emission tips 12 may be carbon-based and the electron emission layer 10, or a portion thereof, may comprise another material such as polysilicon, silicon carbide, or amorphous silicon. In still other embodiments, different numbers of tips may be formed. For example, a single indentation in mold 14 can be used to form a single emission tip 12 on the electron emission layer 10.

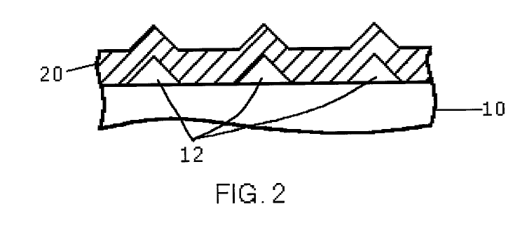

FIG. 2 includes an illustration of a portion of the electron emission layer 10 with emission tips 12 and a first insulating layer 20. The first insulating layer 20 may be formed over the electron emission layer 10 and emission tips 12 (as shown in FIG. 2) and planarized. The first insulating layer 20 may comprise silicon dioxide or other another material with similar insulative properties and may be formed using sputter deposition, chemical vapor deposition (CVD), or other means and may be planarized using conventional chemical or mechanical processes. Layer 20 may have a thickness in the range of approximately 1.0-5.0 microns.

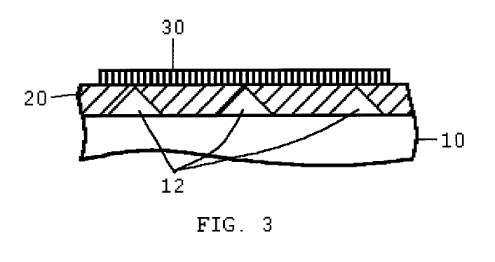

FIG. 3 includes an illustration of an extraction layer 30 formed over the planarized first insulating layer 20. An extraction gate layer 30 may be formed over the first insulating layer 20 by sputter deposition, CVD, or other means and may be planarized using conventional chemical or mechanical processes. The extraction gate layer 30 can comprise molybdenum, titanium, polysilicon, or another similarly reactive and conductive material and may have a thickness in the range of approximately 0.5-5.0 microns thick. The extraction gate layer 30 can be patterned using common photolithographic processes.

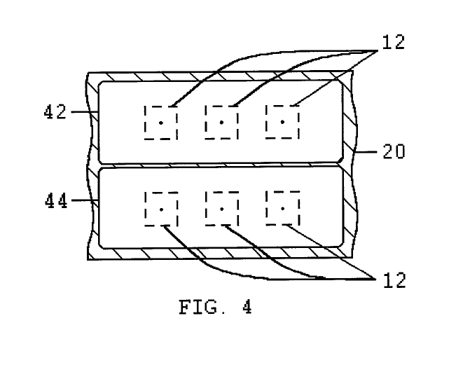

As illustrated in FIG. 4, the patterning can be used to form at least a first extraction gate electrode 42 and a second extraction gate electrode 44. Each of the extraction gate electrodes 42 and 44 may be operated independently of each other and can control the electron flow from at least one underlying emission tip 12. The first extraction gate electrode 42 may comprise a different shape and control a different number of underlying emission tips 40 than the second extraction gate electrode 44. The first extraction gate electrode 42 may be spaced apart and electrically insulated from the second extraction gate electrode 44. Alternatively, the extraction gate layer can be patterned to form one extraction gate electrode that controls all of the underlying emission tips 12.

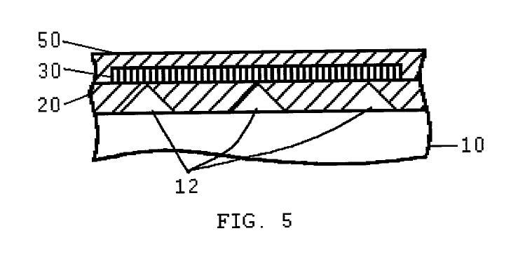

A second insulating layer 50, illustrated in FIG. 5, can be formed over the extraction gate layer 30 by sputter deposition, CVD, or other means and may be planarized using standard chemical or mechanical processes. The second insulating layer 50 may be silicon dioxide or another material with similar insulative properties and can have a thickness in the range of approximately 1.5-1000.0 microns. Typically, the thickness is in a range of approximately 50-300 microns.

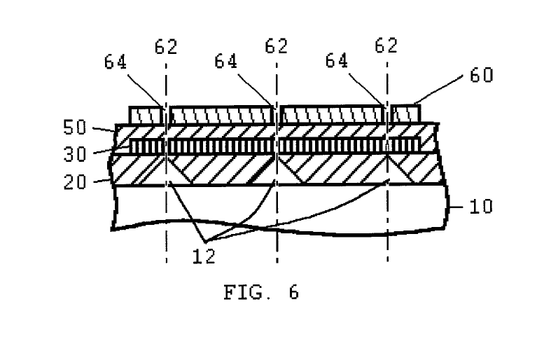

An anode layer 60 may be formed over the second insulating layer 50 as shown in FIG. 6. The anode layer 60 may comprise aluminum, carbon, tungsten, or any material capable of providing a radiation spectrum and can have a thickness in the range of approximately 1.0-100.0 microns. Typically, the thickness is in a range of approximately 10-50 microns. The anode layer 60 may be formed directly over the underlying layer or may be formed independently and fixed above the underlying layer. Typically, the anode layer 60 can be masked and etched to define anode regions and openings 64, each with a diameter (width) in the range of approximately 0.1-0.5 microns, such as 0.3 microns, that may laterally surround central axes 62 of their respective emission tips 12 and extend to the second insulating layer 50. In one embodiment, the openings 64 may be substantially laterally centered about the central axes 62 for their respective tips.

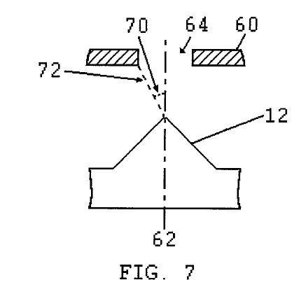

FIG. 7 includes an enlarged view near an emission tip 12. Although intervening layers are present between the tip 12 and the anode layer 60, the intervening layers are not illustrated in FIG. 7 to better illustrate some of the positional relationships between the emission tip 12 and the opening 64 in the anode layer 60. The opening size may vary with emission tip size with the width potentially being limited to a width such that an angle 70 created between the central axis 62 of the emission tip 12 and a line 72 from the emission tip 12 to an inside edge of the opening 64 in the anode layer 60 is approximately 15 degrees or less. The etchant may be any commercially available etchant capable of etching the anode layer such as HCl, H₂S, and other acids or chelating agents, such as ethylene diamine tetra acetic acid (EDTA).

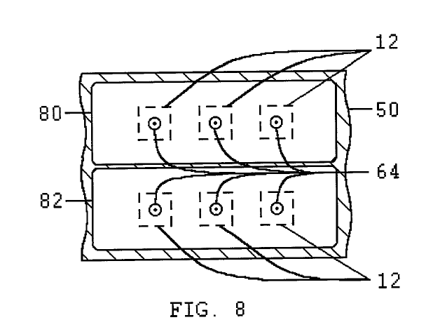

As illustrated in FIG. 8, the anode layer can be formed with at least a first anode region 80 and a second anode region 82. The first anode region 80 may comprise an anode material different from that of the second anode region 82. Each anode region can be the target of electrons from at least one emission tip 12. The first anode region 80 may comprise a different shape and can be the target of a different number of tips 12 than the second anode region 82. The first anode region 80 may be spaced apart or electrically insulated from the second anode region 82. An anode region may be coupled to other anode regions in various time or voltage relationships. Alternatively, the anode layer may be patterned such that one anode region is the target of all tips.

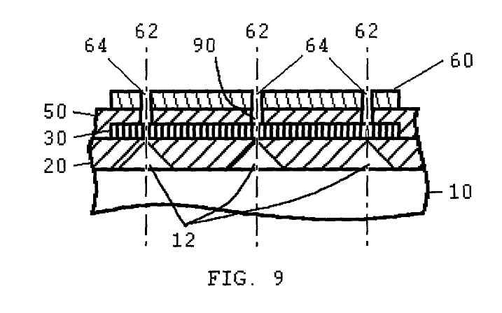

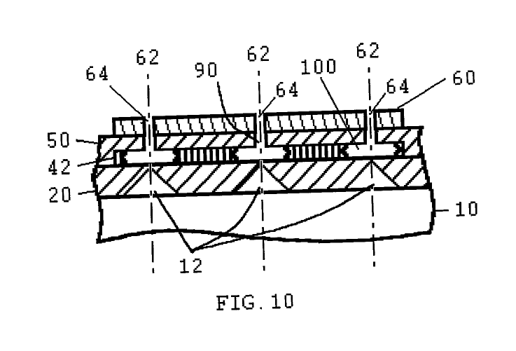

The second insulating layer 50 can be etched anisotropically to define openings 90 that may laterally surround a central axis 62 of the emission tips 12 and extend to the extraction gate layer 30 as illustrated in FIG. 9. The extraction gate layer 30 may be isotropically etched to define openings 100 that may laterally surround a central axis 62 of the emission tips 12 and extend to the first insulating layer 20 as shown in FIG. 10. Openings in the extraction gate layer 100 may be larger than openings in the anode layer 64.

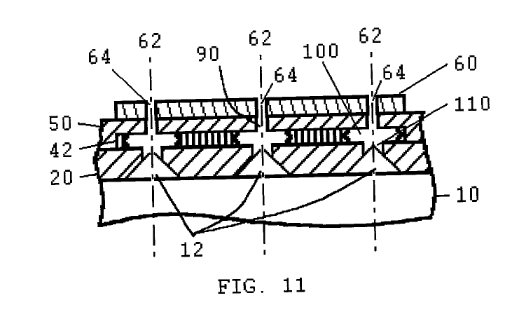

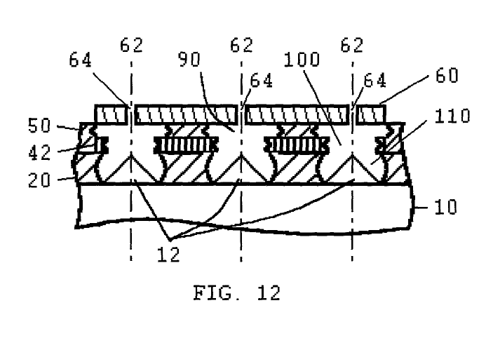

The first insulating layer 20 may be anisotropically etched to define openings 110 that may laterally surround the central axes 62 of the emission tips 12 and extend to the tips 12 as illustrated in FIG. 11. Illustrated in FIG. 12, openings in the first and second insulating layers, respectively 110 and 90, may be expanded using an isotropic etch. Either opening 110 or 90, or both, can be of a larger width than openings 100 in the extraction gate layer 30 and openings 64 in the anode layer 60.

Wire leads (not shown) may be soldered, bonded, or otherwise electrically connected to the extraction gate layer, anode layer, and electron emission layer. The X-radiation source can be placed inside a chamber where a vacuum may be maintained to form a substantially complete X-radiation source.

An X-radiation source produced accordingly may be a monolithic structure in which the physical components of the X-radiation source comprise a semiconductor sandwich structure. Deposition and photolithographic processes can be used to integrally form the electron emission layer, insulating layers, extraction gate layer, and anode layer into substantially one piece. The monolithic X-radiation source described may have a distance between the electron emission layer and the anode layer in the range of approximately 5-1000 microns, and more typically in a range of approximately 50-300 microns. The source can be operated with a voltage differential between the emission tips 12 and anode layer 70 in the range of approximately 0.5-50.0 KV.

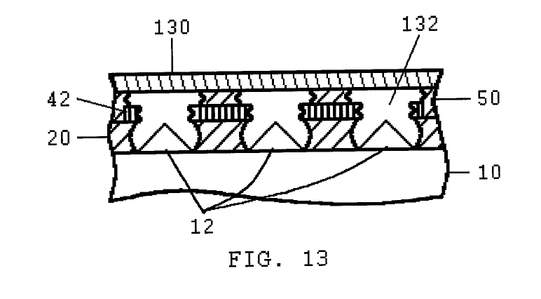

In another embodiment, the electron emission layer 10, first insulating layer 20, extraction gate layer including gate electrodes 42 and 44, and second insulating layer 50 may be formed as previously described. Before forming an anode layer, a mask (not shown) may be formed over the second insulating layer 50 and can be used during etching to define openings in the second insulating layer 50, the extraction gate layer 40, and first insulating layer 20. The anode layer 130 may be formed as a film, tape, or other sufficiently thin configuration. The anode layer 130 may be formed away from the other layers through conventional process and bonded, soldered, or otherwise fixed above the second insulating layer 50 to form a monolithic structure as shown in FIG. 13. A vacuum may be created in the region 132 above the emission layer 10 using conventional methods. While evacuated, the anode layer 130 may be formed such that it does not have openings and may be fixed such that it seals the vacuum in the region 132. Alternatively, the anode layer 130 may include openings as earlier described and may have any openings covered or closed by an X-radiation transparent material.

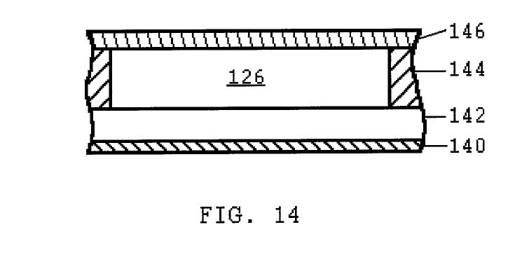

In a different embodiment of the X-radiation source illustrated in FIG. 14, the emission layer may comprise a photo-emitter layer. A photo-emitter layer 142 comprising a material such as Cs—O—Ag, GaAs, CsTe, or the like may be formed over a transparent substrate 140 such as quartz or diamond. A dielectric layer 144 may be formed over the photo-emitter layer 142 and an anode layer 146 may be formed over the dielectric layer 144. Openings (not shown) extending to the dielectric layer may be etched in the anode layer 146 and a cavity 126 in the dielectric layer may be etched using standard etchants. Alternatively, the dielectric may be etched to form the cavity 126 and the anode 146 may be formed apart and fixed to the dielectric. The anode layer 146 may comprise multiple anode regions and each anode region may comprise a different anode material. Individual or groups of anode areas may be selectively activated by directing a light source to selected areas of the photo-emitter layer 142. A light source may be directed or manipulated using diffraction gratings (not shown).

Embodiments of the X-radiation source do not require magnets or substantial magnetic forces to focus or guide electrons from the emission layer to the anode. Still, if desired, one or more magnets could be used.

Embodiments of the X-radiation source may be disposable. Anode layer or insulation layer thickness or material may be selected to provide a limited number of uses such as a single use. Alternatively, anode layer and insulating layer thickness and material may be selected to provide use for a certain time based on X-radiation power or spectral needs. Longer uses or higher powers may require thicker anode and insulating layers. Many X-radiation sources can be used 1-10 times before disposal.

In the foregoing specification, the invention has been described with reference to specific embodiments. However, after reading this specification, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and any element(s) that may cause any benefit, advantage, or solution to occur or become more pronounced are not to be construed as a critical, required or essential feature or element of any or all the claims. As used herein, the terms comprises, comprising, “includes,” “including,” “has,” “having” or any other variation thereof, are intended to cover a non-exclusive inclusion. For example, a process, method, article, or apparatus that comprises a list of elements is not necessarily limited only those elements but may include other elements not expressly listed or inherent to such process, method, article, or apparatus. Further, unless expressly stated to the contrary, “or” refers to an inclusive or and not to an exclusive or. In one example, a condition A or B is satisfied by any one of the following: A is true (or present) and B is false (or not present), A is false (or not present) and B is true (or present), and both A and B are true (or present).

1. An X-radiation source comprising:
an electron emission layer comprising a first side and a second side; and
an anode layer located no more than approximately 1000 microns from the first side of the emission layer.

2. The X-radiation source of claim 1, wherein the electron emission layer further comprises a first emission tip protruding from the first side and a gate electrode layer located between the electron emission layer and the anode layer.

3. The X-radiation source of claim 2, wherein the first emission tip comprises a carbon-based material.

4. The X-radiation source of claim 2, wherein the gate electrode layer comprises gate electrodes configured to operate independently of another gate electrode.

5. The X-radiation source of claim 2, further comprising a first insulating layer and a second insulating layer, wherein:
the first insulating layer lies between the electron emission layer and the gate electrode layer;
the second insulating layer lies between the gate electrode layer and the anode layer;
the first insulating layer, the second insulating layer and the gate electrode layer include a first insulating layer opening, a second insulating layer opening, and a gate electrode layer opening, respectively;
each of the first insulating layer opening, the second insulating layer opening, and the gate electrode layer opening laterally surrounds a central axis extending through the first emission tip, wherein the central axis is substantially perpendicular to the first side of the emission layer; and
each of the first insulating layer opening and the second insulating layer opening has a larger width than the gate electrode layer opening.

6. The X-radiation source of claim 1 wherein the electron emission layer comprises a photo-emitter layer.

7. The X-radiation source of claim 1, wherein the X-radiation source is a monolithic structure.

8. The X-radiation source of claim 1, wherein the anode layer includes a plurality of spaced-apart anode regions.

9. The X-radiation source of claim 8, wherein at least one anode area comprises material that is different from that of other anode areas.

10. The X-radiation source of claim 1, wherein the X-radiation source does not include a magnet.

11. The X-radiation source of claim 1 wherein the anode layer seals a vacuum within a region formed between the electron emission layer and anode layer.

12. A process for forming an X-radiation source comprising:
forming a first insulating layer over an emission layer with a first side, wherein the emission layer comprises a first emission tip protruding from the first side;
forming an extraction gate layer;
forming a second insulating layer;
forming an anode layer; and
etching the second insulating layer, the extraction gate layer, and the first insulating layer to define openings in the second insulating layer, the extraction gate layer, and the first insulating layer, said openings laterally surround a central axis of the first emission tip, said axis being substantially perpendicular to the first side of the emission layer.

13. The process of claim 12, further comprising etching the anode layer to define an opening in the anode layer, said opening in the anode layer laterally surrounding the central axis.

14. The process of claim 12, wherein the first emission tip comprises a carbon based material.

15. The process of claim 12, further comprising molding the first emission tip.

16. The process of claim 15, wherein molding is performed using a mold that comprises a substrate comprising pyramidal indentions.

17. The process of claim 12, further comprising etching the anode layer to define a first anode region and a second anode region, wherein the first anode region comprises a first anode material and a second anode region comprises a second anode material different from the first anode material.

18. The process of claim 12, further comprising:
forming the emission layer with the first side; and
forming the first emission tip on the first side of the emission layer.

19. The process of claim 12, wherein etching further comprises:
anisotropically etching at least a portion of the second insulating layer before etching the first insulating layer; and
isotropically etching at least a portion of the second insulating layer and at least a portion of the first insulating layer.

20. The process of claim 19, wherein after etching is completed, each of the widths of the openings of the first insulating layer and the second insulating layer is larger than the width of the opening of the gate electrode layer.

21. The process of claim 12, further comprising:
patterning the extraction gate electrode layer to form a first extraction gate and a second extraction gate spaced apart and insulated from the first extraction gate; and
patterning the anode layer to form a first anode region and a second anode region spaced apart from the first anode region.

22. An X-radiation source comprising:
an electron source comprising an electron source layer having a first side;
an anode layer insulated from said electron source layer and comprising a first anode region laterally surrounding a first hole extending through the first anode layer.

23. The X-radiation source of claim 22, further comprising:
a first emission tip protruding from the first side of the electron source layer; and
an extraction gate layer lying between the first side of the electron source layer and the anode layer,
wherein the first hole laterally surrounds a first axis extending through the first emission tip substantially perpendicular to the first side of said electron source layer.

24. The X-radiation source of claim 23, wherein the first emission tip comprises a carbon-based material.

25. The X-radiation source of claim 23, wherein the first emission tip comprises a pyramidal shape.

26. The X-radiation source of claim 22, wherein the electron source layer comprises a photo-emitter layer.

27. The X-radiation source of claim 22, wherein:
the anode layer further comprises a second anode region; and
the first anode region comprises a material different from that of the second anode region.

28. The X-radiation source of claim 22, wherein the first hole is less than approximately 0.3 microns in diameter.
